(19) United States
(12) Patent Application Publication
(10) Pub. No.: US 2020/0076198 A1
(43) Pub. Date: Mar. 5, 2020

(54) MICROGRID ENERGY RESERVOIR TRANSACTION VERIFICATION VIA SECURE, DISTRIBUTED LEDGER

(71) Applicant: GENERAL ELECTRIC COMPANY, Schenectady, NY (US)

(72) Inventors: Benjamin Edward BECKMANN, Niskayuna, NY (US); Annarita GIANI, Niskayuna, NY (US); Stephanie KUHNE, Niskayuna, NY (US); Peter KOUDAL, Niskayuna, NY (US); Dan YANG, Niskayuna, NY (US); John William CARBONE, Niskayuna, NY (US); Victor Robert ABATE, Saratoga Spring, NY (US); Keith LONGTIN, Slingerlands, NY (US)

(21) Appl. No.: 16/489,497

(22) PCT Filed: Oct. 12, 2017
(86) PCT No.: PCT/US17/56323

§ 371 Date: Aug. 28, 2019

Related U.S. Application Data
(60) Provisional application No. 62/466,654, filed on Mar. 3, 2017.

(51) Int. Cl. H02J 3/38; H02J 3/32; H02J 3/14; H04L 9/06; H04L 9/32; G06Q 20/36

(52) U.S. Cl. CPC H02J 3/382; H02J 3/32; H02J 3/14; H02J 2003/146; H04L 9/3213; G06Q 20/367; H04L 2209/38; H04L 9/0643

(57) ABSTRACT

A system may include an energy reservoir controller associated with a microgrid's energy reservoir adapted to store energy (e.g., a battery to store electrical energy). A computer processor of the energy reservoir controller may receive indications of digital currency tokens from a token creation platform. At least some of the digital currency tokens may be placed into an available energy container based on an amount of energy stored in the energy reservoir. A consumer within the microgrid may submit a transaction request for energy, and it may be arranged for an amount of energy to be transferred from the energy reservoir to the consumer. Based on the amount of energy transferred to the consumer, a number of digital currency tokens may be moved from the available energy container into a used energy container. Information about the transaction request may then be recorded via a secure, distributed transaction ledger.

### CROSS-REFERENCE TO RELATED APPLICATIONS

The present application claims the benefit of U.S. Patent Application No. 62/466,654 entitled “ENERGY MANAGEMENT SYSTEM AND METHOD” and filed Mar. 2, 2017. The entire contents of that application is incorporated herein by reference.

### BACKGROUND

Some embodiments disclosed herein relate to an energy microgrid having an energy reservoir and, more particularly, to the verification of microgrid energy reservoir transactions via a secure, distributed ledger.

A community (e.g., including residences, businesses, etc.) might want to share one or more local, renewable energy resources. For example, a town might want to share energy generated by individual home solar panels, solar panel farms, wind turbines, etc. Note that some renewable energy resources might only generate power at particular times (e.g., solar panels may only create energy during the day when there is a substantial amount of sunlight, wind turbines may only create energy when there is a substantial amount of wind, etc.). To ensure that energy is available on a consistent basis, the community might utilze an energy reservoir. For example, a community may store electrical energy into a battery and withdraw the energy as it is needed via discrete energy transactions. Various operational needs, business accounting rules, governmental regulations, etc. might require that such energy transactions (e.g., into and/or out of an energy reservoir) be recorded and verifiable (e.g., to support audits, investigations, etc.). It can be difficult, however, to verify various energy transactions within a community, especially when there are a substantial number of energy transfers and/or community members. It would therefore be desirable to provide systems and methods to efficiently and accurately facilitate verification of microgrid energy reservoir transactions via a secure, distributed ledger.

### SUMMARY

According to some embodiments, a system may include an energy reservoir controller associated with a microgrid's energy reservoir adapted to store energy (e.g., a battery to store electrical energy). A computer processor of the energy reservoir controller may receive indications of digital currency tokens from a token creation platform. At least some of the digital currency tokens may be placed into an available energy container based on an amount of energy stored in the energy reservoir. A consumer within the microgrid may submit a transaction request for energy, and it may be arranged for an amount of energy to be transferred from the energy reservoir to the consumer. Based on the amount of energy transferred to the consumer, a number of digital currency tokens may be moved from the available energy container into a used energy container. Information about the transaction request may then be recorded via a secure, distributed transaction ledger.

Some embodiments comprise: means for receiving, at a battery controller computer processor, indications of digital currency tokens from a token creation platform via a communication network; means for placing, by the battery controller computer processor, at least some of the digital currency tokens into a reserve container; based on an amount of energy stored in a battery associated with the microgrid, means for moving at least some of the digital currency tokens from the reserve container into an available energy container; means for receiving, from a consumer within the microgrid, a transaction request for energy; responsive to the transaction request, means for arranging for an amount of energy to be transferred from the battery to the consumer; based on the amount of energy transferred to the consumer, means for automatically moving a number of digital currency tokens from the available energy container into a used energy container associated with the consumer; and means for recording information about the transaction request via a secure, distributed transaction ledger.

Technical effects of some embodiments of the invention are improved and computerized ways to efficiently and accurately facilitate verification of microgrid energy reservoir transactions via a secure, distributed ledger. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is a high-level block diagram of a system according to some embodiments.

FIG. 2 is a method that may be associated with a microgrid in accordance with some embodiments.

FIG. 3 is a high-level block diagram of a system including an energy reservoir controller and an energy reservoir according to some embodiments.

FIG. 4 illustrates an interactive microgrid energy system user display in accordance with some embodiments.

FIG. 5 is a system implementing microgrid energy transactions with blockchain validation according to some embodiments.

FIG. 6 is a system implementing microgrid energy transactions with multiple energy transaction engines in accordance with some embodiments.

FIG. 7 illustrates a platform according to some embodiments.

FIG. 8 is a portion of a reserve container in accordance with some embodiments.

FIG. 9 is a portion of an available container according to some embodiments.

FIG. 10 is a portion of a used container in accordance with some embodiments.

FIG. 11 is a distributed ledger reference architecture according to some embodiments.

FIG. 12 is a high-level block diagram of a system including an energy reservoir controller and an energy reservoir according to some other embodiments.

FIG. 13 is a high-level block diagram of a system including a battery controller and multiple batteries according to some embodiments.

FIG. 14 illustrates a schematic diagram representing an energy management system in accordance with an embodiment of the present technique.

FIG. 15 illustrates a block diagram representing a method for energy management in accordance with an embodiment of the present technique.

FIG. 16 illustrates a schematic diagram representing a handheld device in accordance with an embodiment of the present technique.

### DETAILED DESCRIPTION

In the following detailed description, numerous specific details are set forth in order to provide a thorough understanding of embodiments. However, it will be understood by those of ordinary skill in the art that the embodiments may be practiced without these specific details. In other instances, well-known methods, procedures, components and circuits have not been described in detail so as not to obscure the embodiments.

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

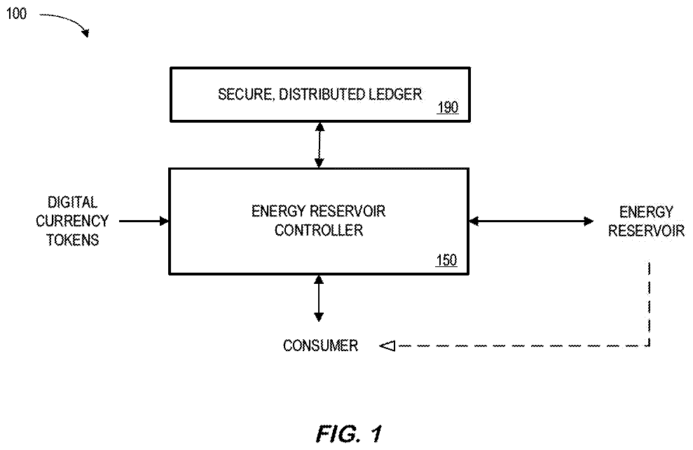

It may generally be desirable to efficiently and accurately facilitate verification of microgrid energy reservoir transactions via a secure, distributed ledger. FIG. 1 is a high-level block diagram of a system 100 according to some embodiments. In particular, the system 100 includes an energy reservoir controller 150 that communicates with an energy reservoir associated with a microgrid. As used herein, the phrase “energy reservoir” might refer to, for example, one or more energy storage devices such as batteries adapted to store electricity for a microgrid support from approximately three to approximately several hundred energy consumers. As used herein, th term “energy consumer” may refer to individuals who consume or otherwise demand energy for their use as well as electrical loads, devices, appliances, vehicles, residences, buildings, or other objects or entities, both public and private, that may consume, or in some circumstances, generate energy. The energy reservoir might be adapted to store energy generated by a local renewable energy source coupled to the microgrid (e.g., solar panels, wind turbines, hydroelectric energy sources, electric vehicle batteries, etc.). As used herein, the term “microgrid” may refer to any network associated with power distribution including networks that can stand alone (e.g., are isolated) as well as networks that are connected to a larger electrical grid. In certain embodiments, the energy reservoir may in addition or instead be adapted to store energy generated by non-renewable sources such as combustion or compression sources.

According to some embodiments, the energy reservoir controller 150 may also receive digital currency tokens. As used herein, the phrase “digital currency token” might be associated with, for example, a decentralized cryptocurrency such as Bitcoin or a similar digital asset that serves as a medium of exchange using cryptography to secure the transactions and/or control the creation of additional units of the currency. A cryptocurrency may be produced at a rate defined when the system is created. Within the cryptocurrency system the safety, integrity and balance of ledgers may be maintained by a community of entities utilizing, for example, the Secure Hash Algorithm (“SHA”) 256 cryptographic hash function, the X11 algorithm, the Equihash mining algorithm, the Scrypt key derivation function, etc.

The energy reservoir controller 150 may also communicate with one or more consumers associated with the microgrid. For example, the energy reservoir controller 150 might arrange for the consumer to receive energy from the energy reservoir (as indicated by the dashed line in FIG. 1, arrange for the consumer to provide payment for the energy, etc. Various aspects of the digital currency tokens and/or energy transaction with a consumer may be stored in a secure, distributed ledger 190, such as a ledger that utilizes “blockchain” technology. As used herein, the term “blockchain” may refer to a list of records, called blocks, which are linked and secured using cryptography. Each block may contain, for example, a hash pointer as a link to a previous block, a timestamp, transaction data, etc. As a result, a blockchain may be resistant to data modification or tampering allowing parties to efficiently record information in a verifiable and permanent way. According to some embodiments, a blockchain is managed by a peer-to-peer network that adheres to a protocol for validating new blocks. Once recorded, the data in a block cannot be altered retroactively without the alteration of all subsequent blocks. Note that the energy reservoir controller 150 could be completely de-centralized and/or might be associated with a third party, such as a vendor that performs a service for an enterprise.

The energy reservoir controller 150 might be, for example, associated with a Personal Computer (“PC”), laptop computer, a tablet computer, a smartphone, an enterprise server, a server farm, an Application Specific Interface Circuit (“ASIC”), a single board microcontroller card, an energy transaction engine, and/or a database or similar storage devices. According to some embodiments, an “automated” energy reservoir controller 150 may automatically facilitate energy transactions for microgrid energy consumers. As used herein, the term “automated” may refer to, for example, actions that can be performed with little (or no) intervention by a human.

As used herein, devices, including those associated with the energy reservoir controller 150 and any other device described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The energy reservoir controller 150 may store information into and/or retrieve information from data stores (e.g., containers local to the controller and/or other data stores). The data stores might, for example, store electronic records representing digital currency tokens, energy transactions currently in process, etc. The data stores may be locally stored or reside remote from the energy reservoir controller 150. Although a single energy reservoir controller 150 is shown in FIG. 1, any number of such devices may be included and may be configured in a centralized, distributed, or cloud-based configuration. Moreover, various devices described herein might be combined according to embodiments of the present invention. For example, in some embodiments, the energy reservoir controller 150, a device creating digital currency tokens, the secure distributed ledger 190, and/or other devices might be co-located and/or may comprise a single apparatus.

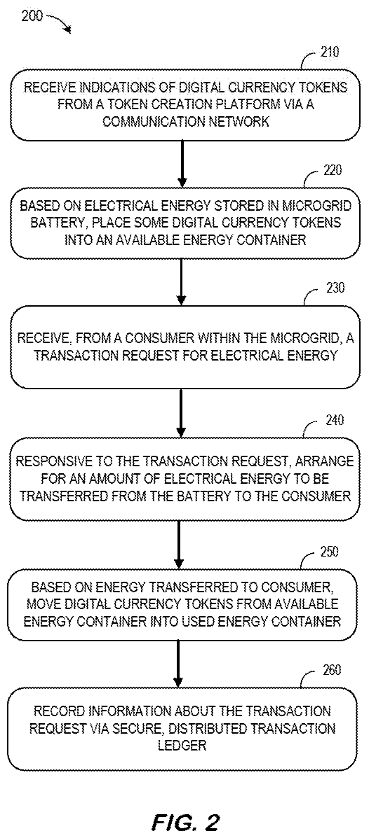

In this way, the system 100 may efficiently and accurately facilitate verification of microgrid energy reservoir transactions via a secure, distributed ledger 190. For example, FIG. 2 illustrates a method 200 that might be performed by the energy reservoir controller 150 and/or other elements of the system 100 described with respect to FIG. 1, or any other system, according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At 210, an energy reservoir controller 150 may receive indications of digital currency tokens from a token creation platform via a communication network. For example, an energy reservoir controller (e.g., a battery controller) computer processor might receive indications of digital “coins” from a token creation platform via the Internet or other communication port. Note that the token creation platform might be remove from the microgrid or be local (e.g., processing power local to a reservoir may be a participant in the generation of tokens or coins).

Based on an amount of energy stored in an energy reservoir (e.g., a battery associated with a microgrid), the system may place at least some of the digital currency tokens into an available energy “container” at 220. As used herein, the term “container” might refer to an electronic record, database, list, buffer, or any similar information storage device or structure. Note that each token might represent a percentage of an amount of energy (e.g., 0.1% of a battery's maximum storage capacity), a fixed amount of energy (e.g., kilo-watt hours), an amount of money, etc. For example, tokens might be assigned to a container when a user deposits energy into the reservoir from their own source (e.g., solar panels), when energy is received from a larger electrical grid, etc.

At 230, a transaction request for energy may be received from a consumer within the microgrid. For example, the consumer might indicate that he or she would like to receive 100 tokens worth of electrical energy. According to some embodiments, energy may be transferred to a consumer by making a certain quantity of kWh available for consumption. In this case, tokens may move from a reserve container to an available container (e.g., electronic records in those containers may be updated to reflect such a transition). Responsive to the transaction request, the system may arrange for an amount of energy to be transferred from the battery to the consumer at 240. Based on the amount of energy transferred to the consumer, the system may automatically move a number of digital currency tokens from the available energy container into a used energy container associated with the consumer at 250 (e.g., indicating that a consumer has “used” that energy). At 260, the system may record information about the transaction request via a secure, distributed transaction ledger. For example, information may be recorded via blockchain technology so that transactions can later be audited, verified, traced, etc.

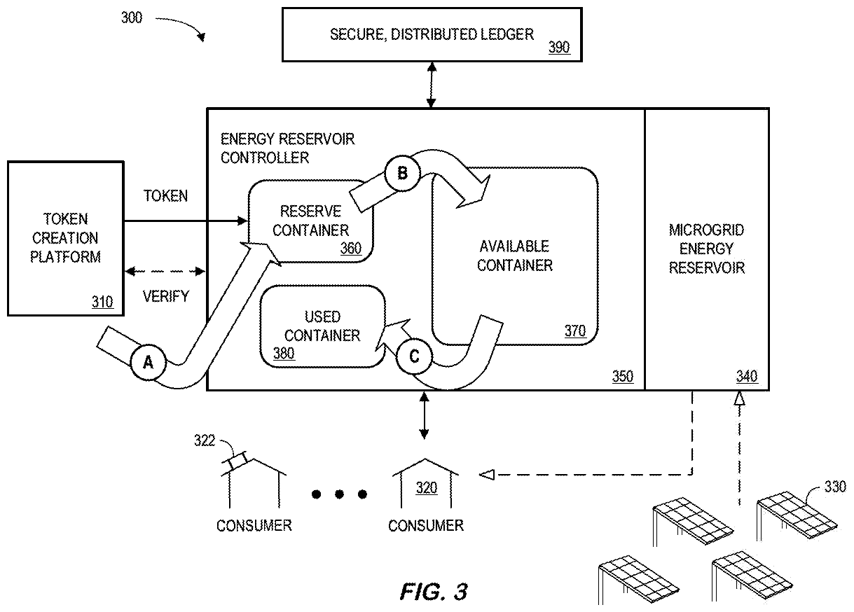

FIG. 3 is a high-level block diagram of a system 300 including an energy reservoir controller 350 and a microgrid energy reservoir 340 according to some embodiments. The energy reservoir 340 may store energy generated by a local solar panel farm 330 and provide energy to consumers 320 (e.g., as illustrated by dashed arrows in FIG. 3). According to some embodiments, consumers may also generate energy (e.g., via a solar panel 322) that is stored into the microgrid energy reservoir 340.

At (A), the energy reservoir controller 350 may receive digital currency tokens from a token creation platform 310. For example, the token creation platform 310 might mine digital “coins” that are transmitted to the energy reservoir controller 350. In one embodiment, the digital coins may be referred to as “BTU Coins.” The energy reservoir controller 350 may initially place these tokens into a “reserve” container 360. At (B), some of the tokens may be transferred from the reserve container 360 to an “available” container 370 based on the amount of energy that is currently stored in the energy reservoir 340. For example, if the energy reservoir 340 receives a large amount of energy from the solar panel farm 330, a relatively large number of tokens may be moved from the reserve container 360 to available container 370. A consumer 320 may then transmit an energy transaction request to the energy reservoir controller 350 (e.g., the consumer 320 may ask for or use a particular number of kilo-watt hours). The energy reservoir controller 350 arranges for this energy to be transferred from the microgrid energy reservoir 340 to the consumer 320 and moves a corresponding number of digital currency tokens from the available container 370 into a “used” container 380 at (C) (e.g., representing the amount of energy that is no longer stored in the energy reservoir 340).

According to some embodiments, the energy reservoir controller 350 may also access the remote token creation platform 310 to verify data associated with a transaction request. Similarly, the energy reservoir controller 350 may record information about an energy transaction in a secure, distributed ledger 390 (e.g., utilizing blockchain technology).

Thus, some embodiment may provide a microgrid for a plurality of consumers 320 that utilizes a token creation platform 310 (e.g., a digital coin “miner”). The system 100 includes an energy reservoir 340 (e.g., a battery) that stores energy created by a localized renewable energy source (e.g., the solar panel farm 330). The community's load may be meet and be managed by an energy reservoir controller 350 or control system such that the reservoir 340 can request, collect, and use energy. The tokens or coins stored in the reserve container 360 are created by a “mining process.” As used herein, the phrase “mining process” may refer to, for example, a way to form a distributed timestamp server as a peer-to-peer network, such as a proof-of-work system. According to some embodiments, a signature may be discovered (e.g., at a data center) and proof-of-work may provide the signature for a blockchain. By way of example, a mining process may involve identifying a block that when hashed twice with SHA-256 yields a number smaller than a threshold value. According to some embodiments, tokens or coins in the used container 380 may eventually be recycled and placed back into the reserve container 360. The number of tokens or coins in the available container 370 represent the energy stored in the energy reservoir 340. Note that the transactional infrastructure might be located both at/within the energy reservoir 340, devices within the energy delivery, and/or various communication networks.

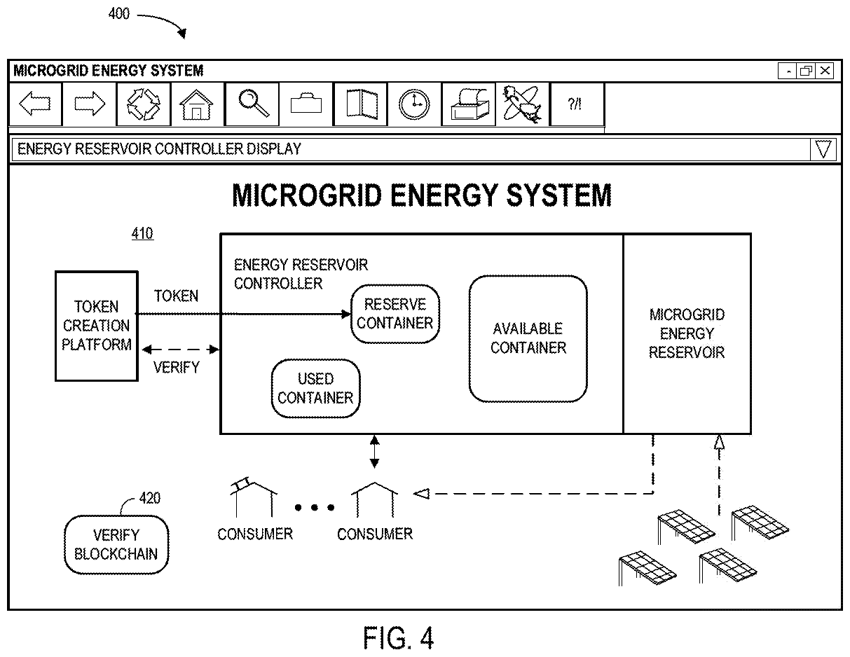

FIG. 4 illustrates an interactive microgrid energy system user display 400 in accordance with some embodiments. The display 400 includes a graphical representation 410 of elements of a microgrid (e.g., the token creation platform, energy reservoir controller, energy reservoir, energy sources, consumers, etc.). According to some embodiments, selection of a graphical element on the display 400 may result in a popup window displaying further details about that element (e.g., how much electricity is currently stored in a battery) and/or allow an operator to adjust parameters associated with that element (e.g., to turn a token creation platform “on” or “off”). According to some embodiments, selection of a graphical icon 420 via a computer mouse or touchscreen might, for example, perform a blockchain verification of an energy transaction, generate a report, transmit a status message to consumers, etc.

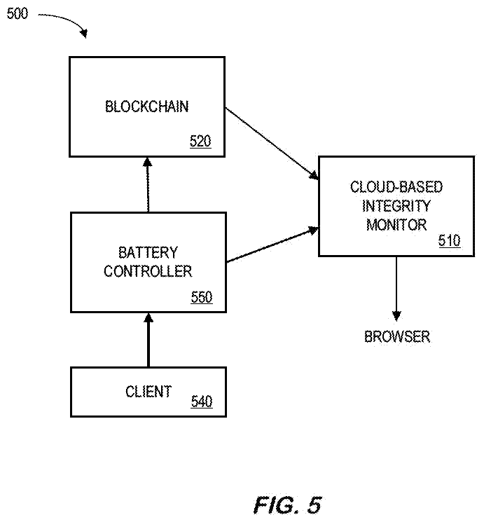

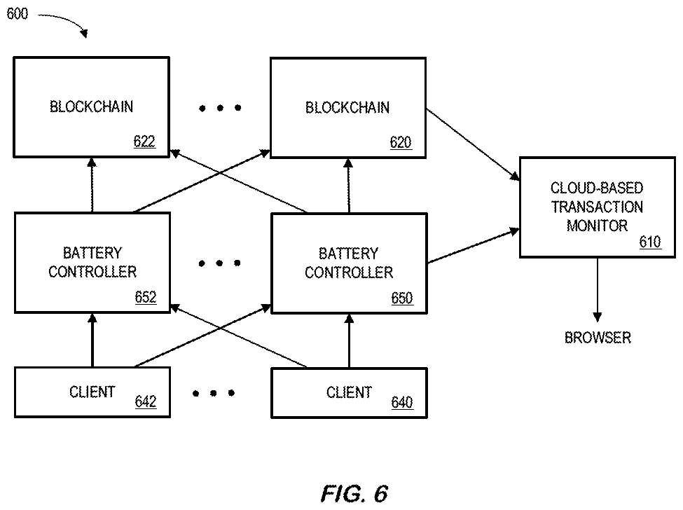

An energy reservoir controller and/or other elements of a microgrid system may record information about the transaction using a secure, distributed transaction ledger (e.g., via a blockchain verification process). For example, the energy reservoir controller might record a request date and time, an amount of energy, a consumer identifier, a price, a bid, etc. via the secure, distributed transaction ledger in accordance with any of the embodiments described herein. According to some embodiments, the distributed ledger might be associated with the HYPERLEDGER® blockchain verification system. FIG. 5 is a system 500 implementing an energy transaction incorporating blockchain validation according to some embodiments. A cloud-based integrity monitor 510 may provide transaction integrity data via a web browser and exchange information with a blockchain 520 (or other secure distributed transaction ledger) and a battery controller 550 via Representational State Transfer (“REST”) web services or other similar web services. The REST web services may, for example, provide interoperability between computer systems on the Internet (e.g., by allowing requesting systems to access and manipulate textual representations of web resources using a uniform, predefined set of stateless operations). According to some embodiments, portions of the battery controller 550 may be associated with a database, such as a MySQL database. In this way, the battery controller 550 and blockchain 520 can be used to provide transaction level verification for a client 540 (including, for example, information about one or more energy transactions). Although FIG. 5 illustrates a system 500 with a single blockchain 520 and battery controller 550, note that embodiments may employ other topologies. For example, FIG. 6 is a system 600 implementing an energy transaction incorporating multiple battery controllers in accordance with some embodiments. In particular, an additional blockchain 622 and battery controller 652 may provide protection for an additional client 642. As illustrated in FIG. 6, each battery controller 650, 652 may be associated with multiple blockchains 620, 622 providing additional protection for the system 600 (e.g., by storing information at multiple, geographically disperse nodes making attacks impractical). That is, each verifier (e.g., battery controller 650, 652) may commit a brief summary to an independent data store (including for example, information about an energy sale) and, once recorded, the information cannot be changed without detection to provide a tamper-proof System of Records (“SoR”).

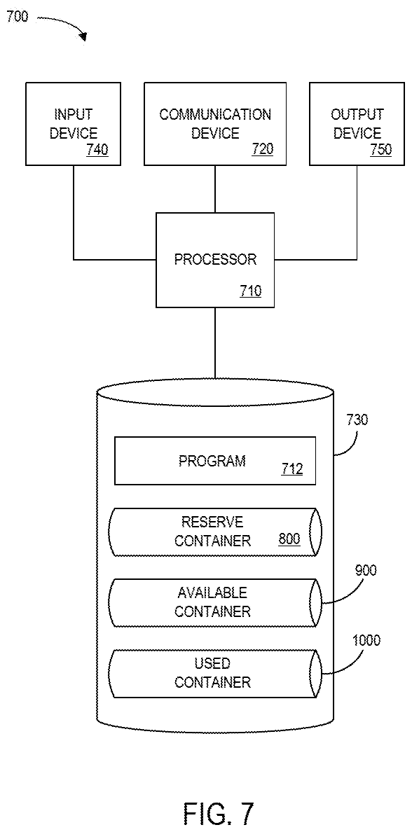

Embodiments described herein may comprise a tool that facilitates verification of microgrid energy reservoir transactions via a secure, distributed ledger and may be implemented using any number of different hardware configurations. For example, FIG. 7 illustrates a platform 700 that may be, for example, associated with the systems 70, 300 of FIGS. 1 and 3, respectively (as well as other systems described herein). The platform 700 comprises a processor 710, such as one or more commercially available Central Processing Units (“CPUs”) which may be in the form of one-chip microprocessors, coupled to a communication device 720 configured to communicate via a communication network (not shown in FIG. 7). The communication device 720 may be used to communicate, for example, with one or more token creation platforms, secure, distributed ledgers, consumers, or energy transaction engines. Note that communications exchanged via the communication device 720 may utilize security features, such as those between a public internet user and an internal network of an insurance enterprise. The security features might be associated with, for example, web servers, firewalls, and/or PCI infrastructure. The platform 700 further includes an input device 740 (e.g., a mouse and/or keyboard to enter information about a battery, a consumer, a distributed ledger, etc.) and an output device 750 (e.g., to output energy reports, generate energy status messages, etc.).

The processor 710 also communicates with a storage device 730. The storage device 730 may comprise any appropriate information storage device, including combinations of magnetic storage devices (e.g., a hard disk drive), optical storage devices, mobile telephones, and/or semiconductor memory devices. The storage device 730 stores a program 712 and/or network security service tool or application for controlling the processor 710. The processor 710 performs instructions of the program 712, and thereby operates in accordance with any of the embodiments described herein. For example, the processor 710 may receive indications of digital currency tokens from a token creation platform. At least some of the digital currency tokens may be placed by the processor 710 into an available energy container based on an amount of energy stored in the energy reservoir. A consumer within the microgrid may submit a transaction request for energy, and the processor 710 may arrange for an amount of energy to be transferred from the energy reservoir to the consumer. Based on the amount of energy transferred to the consumer, a number of digital currency tokens may be moved by the processor 710 from the available energy container into a used energy container. Information about the transaction request may then be recorded by the processor 710 via a secure, distributed transaction ledger.

The program 712 may be stored in a compressed, uncompiled and/or encrypted format. The program 712 may furthermore include other program elements, such as an operating system, a database management system, and/or device drivers used by the processor 710 to interface with peripheral devices.

As used herein, information may be “received” by or “transmitted” to, for example: (i) the platform 700 from another device; or (ii) a software application or module within the platform 700 from another software application, module, or any other source.

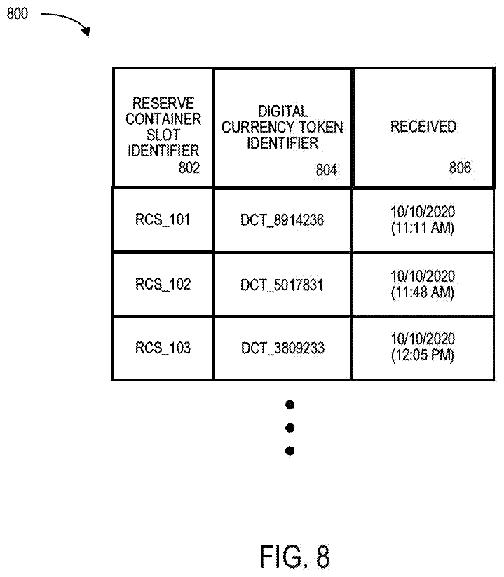

In some embodiments (such as shown in FIG. 7), the storage device 730 further stores a reserve container 800, an available container 900, and a used container 1000. Examples of databases that might be used in connection with the platform 700 will now be described in detail with respect to FIGS. 8 through 1000. Note that the databases described herein are only examples, and additional and/or different information may be stored therein. Moreover, various databases might be split or combined in accordance with any of the embodiments described herein. For example, the containers 800, 900, 1000 might be combined and/or linked to each other within the program 712.

Referring to FIG. 8, a table is shown that represents the reserve container 800 that may be stored at the platform 700 in accordance with some embodiments. The table, which contains a list of transactions, may include, for example, entries identifying slots that may store indications of digital currency tokens (e.g., coins) ready to be used by the microgrid. The table may also define fields 802, 804, 806 for each of the entries. The fields 802, 804, 806 may, according to some embodiments, specify: a reserve container slot identifier 802, a digital currency token identifier 804, and a received indication 806. The reserve container 800 may be created and updated, for example, based on information electrically received from remote token creation platforms (e.g., “coin miners”), data recycled from the used container 1000, etc.

The reserve container slot identifier 802 may be, for example, a unique alphanumeric code identifying a location or position within the container 800. The digital currency token identifier 804 might comprise a specific digital coin value, a pointer to where the digital coin value is stored, etc. The received indication 806 might comprise, for example, a date and time indicating when the coin in that particular slot was received from a remote token creation platform.

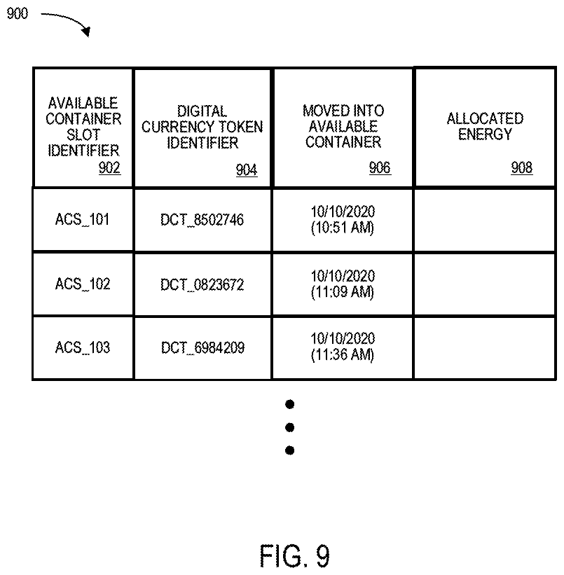

FIG. 9 is a portion of an available container 900 according to some embodiments. The table may include, for example, entries identifying tokens that represent an amount of energy currently available for the microgrid (e.g., that is stored in an associated energy reservoir or battery). The table may also define fields 902, 904, 906, 908 for each of the entries. The fields 902, 904, 906, 908 may, according to some embodiments, specify: an available container slot identifier 902, a digital currency token identifier 904, a moved into available container indication 906, and allocated energy 908. The available container 900 may be created and updated, for example, based on information electrically received from an energy reservoir or battery, a local renewable energy resource, etc.

The available container slot identifier 902 may be, for example, a unique alphanumeric code identifying a location or position within the container 900. The digital currency token identifier 904 might comprise a specific digital coin value, a pointer to where the digital coin value is stored, etc. and could be based on or associated with the digital currency token identifier 804 stored in the reserve container 800. The moved into available container indication 806 might comprise, for example, a date and time indicating when the coin in that particular slot was moved from the reserve container 800 into the available container 900. The allocated energy 908 might define an amount of energy represented by that particular slot or entry (e.g., an amount of energy currently stored in an energy reservoir or battery).

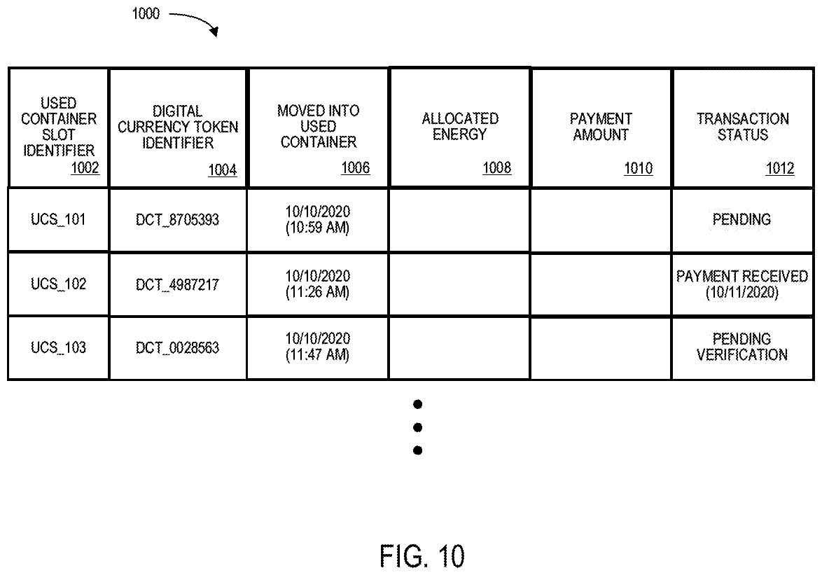

FIG. 10 is a portion of a used container 1000 in accordance with some embodiments. The table may include, for example, entries identifying energy that has been used by microgrid consumers. The table may also define fields 1002, 1004, 1006, 1008, 1010, 1012 for each of the entries. The fields 1002, 1004, 1006, 1008, 1010, 1012 may, according to some embodiments, specify: a used container slot identifier 1002, a digital currency token identifier 1004, a moved into used container indication 1006, allocated energy 1008, payment amount 1010, and transaction status 1012. The used container 1000 may be created and updated, for example, based on information electrically received from remote consumers, an energy reservoir, etc.

The used container slot identifier 1002 may be, for example, a unique alphanumeric code identifying a location or position within the container 1000. The digital currency token identifier 1004 might comprise a specific digital coin value, a pointer to where the digital coin value is stored, etc. and could be based on or associated with the digital currency token identifier 904 stored in the available container 900. The moved into used container indication 806 might comprise, for example, a date and time indicating when the coin in that particular slot was moved from the available container 900 into the used container 1000. The allocated energy 1008 might define an amount of energy represented by that particular slot or entry (e.g., an amount of energy used by a microgrid consumer). The payment amount 1010 indicates a payment value that the consumer should provide in exchange for the energy (e.g., the allocated energy 1008 multiplied by a current energy price or rate). The transaction status 1012 might indicate that payment is still pending, when payment was received, etc. Note that the records in tables described herein may also be represented as accounts with a balance, and each account may have an accompanying list of transactions that collectively produce the account's balance. According to some embodiments, a set of accounts may be combined into a collective wallet and a collective may then represent the state of a specific entity (e.g., associated with the reserved container 800, the available container 900, and the used container 1000).

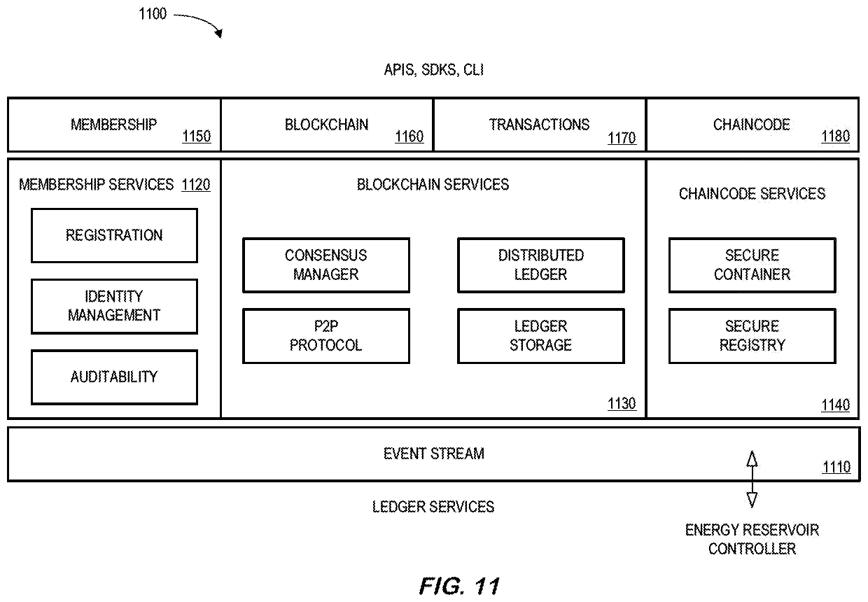

Embodiments may be associated with any type of distributed ledger having a de-centralized consensus-based network that supports smart contracts, digital assets, record repositories, and/or cryptographic security. For example, FIG. 11 is a distributed ledger reference architecture 1100 according to some embodiments. The architecture 1100 includes ledger services and an event stream 1110 that may contain microgrid energy transaction information (e.g., from an energy reservoir controller). Membership services 1120 (e.g., including registration, identity managements, and/or an auditability process) may manage identity, privacy, and confidentiality for membership 1150 for the network security service. Blockchain services (e.g., including a consensus manager, Peer-to-Peer (“P2P”) protocol, a distributed ledger, and/or ledger storage) may manage the distributed ledger, for example, through a P2P protocol to maintain a single state that replicated at many nodes to support blockchains 1160 and transactions 1170. Chaincode services 1140 (e.g., secure container and/or a secure registry associated with a smart contract) may help compartmentalize smart contract (or chaincode 1180) execution on validating nodes. Note that the environment may be a “locked down” and secured container with a set of signed base images that contain a secure OS and programming languages. Finally, APIs, Software Development Kits (“SDKs”), and/or a Command Line Interface (“CLI”) may be utilized to support a network security service via the reference architecture 1100.

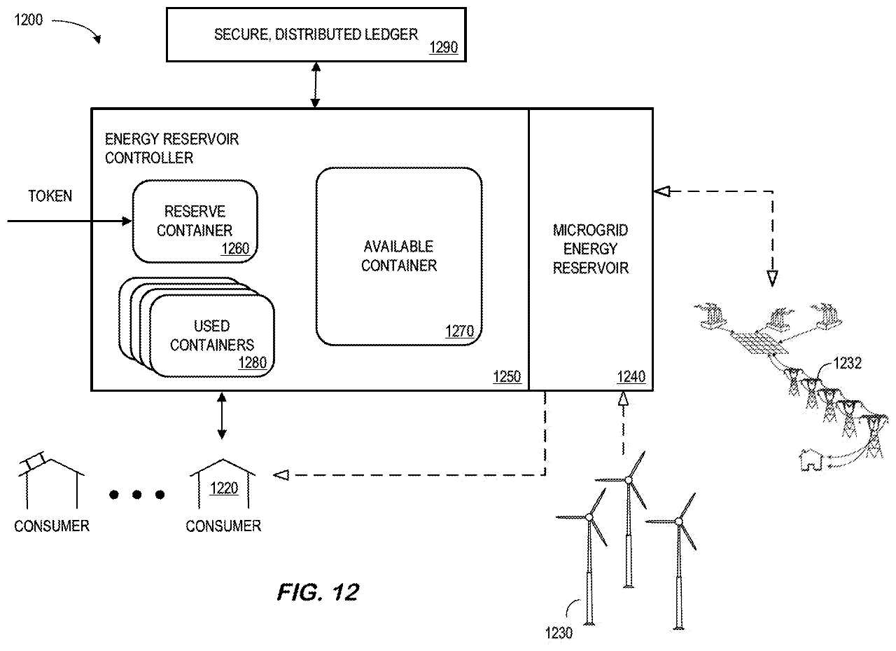

The systems described herein are provided only as examples, and embodiments may have various other configurations. For example, FIG. 12 is a high-level block diagram of a system 1200 including an energy reservoir controller and an energy reservoir according to some other embodiments. In particular, a microgrid energy reservoir 1240 may store energy generated by local wind turbines 1230 and provide energy to consumers 1220 (e.g., as illustrated by dashed arrows in FIG. 12). According to this embodiment, an energy reservoir controller 1250 and/or the energy reservoir 1240 may also exchange energy with a larger electrical grid 1232 (e.g., to sell excess electrical energy to purchase additional electrical energy for consumers 1220 when required).

As before, the energy reservoir controller 1250 may receive digital currency tokens and place these tokens into a reserve container 1260. Some of the tokens may then be transferred from the reserve container 1260 to an available container 1270 based on the amount of energy that is currently stored in the energy reservoir 1240 and/or available from the larger electrical grid 1232. A consumer 1220 may then transmit an energy transaction request to the energy reservoir controller 1250 which arranges for an amount of energy to be transferred from the microgrid energy reservoir 1240 to the consumer 1220. The energy reservoir controller 1250 also moves a corresponding number of digital currency tokens from the available container 1270 into a used container 1280 (e.g., representing the amount of energy that is no longer stored in the energy reservoir 1240). Note that the microgrid is associated with a plurality of consumers, and a separate used energy container 1280 could be maintained for each consumer (that is, each used or burned coin account might represent a customer's usage over a period of time). The system 1200 may then arrange to receive payment from each consumer 1220 based on the number of digital currency tokens in the associated used energy container 1280 (e.g., the number or coins can be translated into their electrical bill). According to some embodiments, the energy reservoir controller 1250 may also record information about an energy transaction in a secure, distributed ledger 1290 (e.g., utilizing blockchain technology).

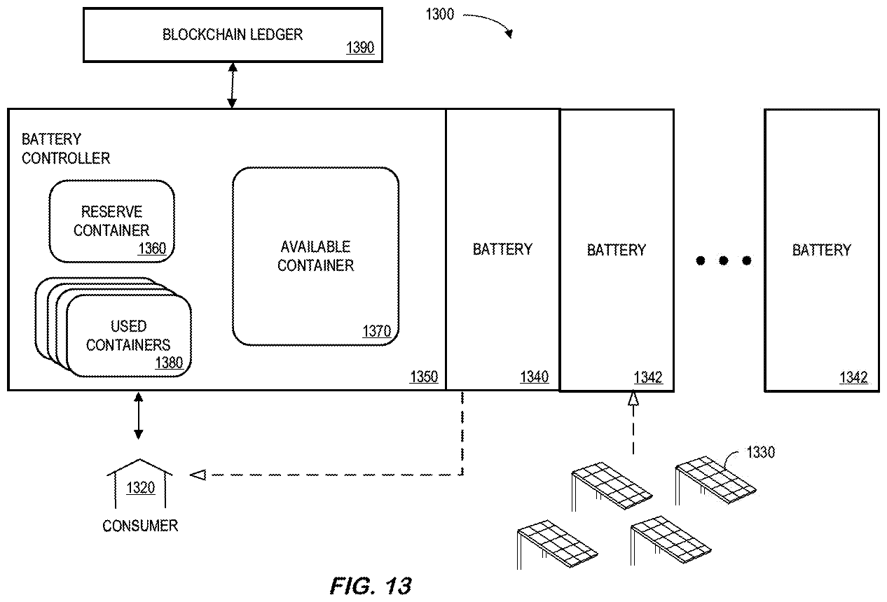

FIG. 13 is a high-level block diagram of a system 1300 including a battery controller 1350 and multiple microgrid batteries 1340, 1342 (e.g., powered by solar panels 1330) according to some embodiments. As before, the battery controller 1350 may receive digital coins and place these coins into a reserve container 1360. Some of the coins may then be transferred from the reserve container 1360 to an available container 1370 based on the amount of energy that is currently stored in the batteries 1340, 1342. A consumer 1320 may then transmit an energy transaction request to the battery controller 1350 which arranges for an amount of electrical energy to be transferred from the microgrid batteries 1340, 1342 to the consumer 1320. The battery controller 1350 also moves a corresponding number of coins from the available container 1370 into a used container 1380 (e.g., representing the amount of electrical energy that is no longer stored in the batteries 1340, 1342). According to some embodiments, the battery controller 1350 may also record information about an energy transaction in a secure, distributed blockchain ledger 1390. In this way, a plurality of batteries 1340, 1342 may comprise a “mega-reservoir” capable of supporting larger communities. Note that an energy reservoir might be implemented as a box including racks of modules with each module containing many cells. Some installations may include multiple boxes. As used herein, the terms “battery” and “batteries” are not limited to any particular size or configuration. Moreover, although a battery may be coupled to a controller, note that there does not need to be a 1:1 ratio between batteries and controllers (e.g., a centralized controller may be provided). For example, each box or battery string might have its own DC-DC converter but a single battery controller 1350 may or may not be shared.

Thus, embodiments may solve challenges for transnational accounting within a community whose energy load is served by a renewable reservoir. Some embodiments may allow for community members, and the reservoir itself, to monitor and/or predict their energy usage. Embodiments may also produce verifiable transactions that can be used for billing, taxation, etc. In general, embodiments may allow for the localization of energy availability, demand, usage, forecasting, billing, etc. This information might be made available to, for example, an energy consumer, a reservoir, an energy generator, etc. In addition, the information might be shared with other interested individuals and organizations, including government agencies, utilities, other reservoirs, etc. The secure, distributed way in which energy transaction are recorded may facilitate the trading of energy within a microgrid, among neighboring microgrid communities, a larger energy grid, etc.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with embodiments of the present invention (e.g., some of the information described herein may be combined or stored in external systems). Moreover, although embodiments have been described with respect to particular types of local renewable energy resources, note that embodiments might be associated with other types of generators including dams, etc. Similarly, the displays shown and described herein are provided only as examples, and other types of displays and display devices may support any of the embodiments.

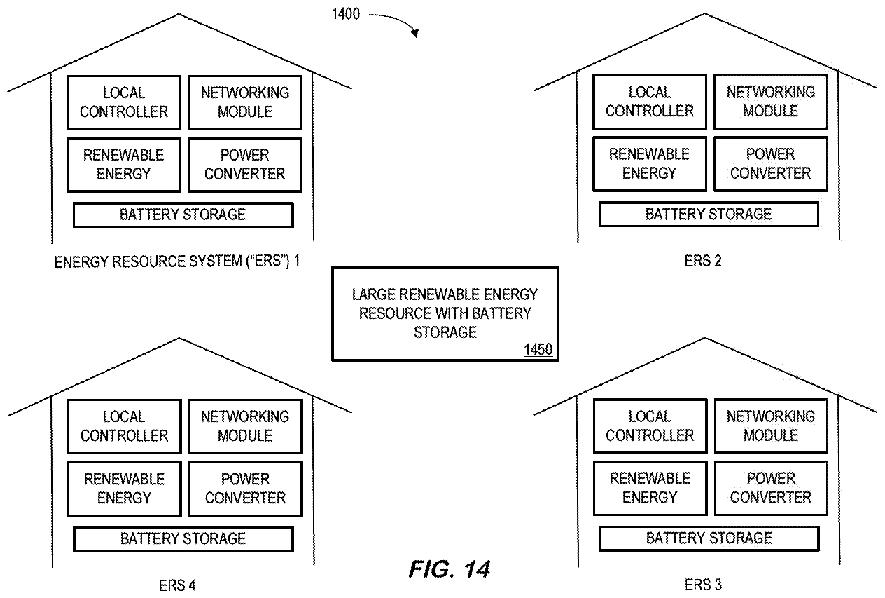

Some embodiments have been described with respect to solar panels and wind turbines, but note that Electric Vehicles (“EV”) and/or Hybrid Electric Vehicles (“HEV”) might also be used to as an energy source and/or energy sink. For example, a secure, distributed ledger might be used to track a person's use and/or contribution of energy in connection with an EV. A person who charges their car at a public location may be debited an amount from an account or may instead charge the car's batteries at home using excess power from solar panels and then “donate” the electricity to another consumer who may need it. This could be, for example, a public battery bank or charity. For example, FIG. 14 shows an energy management system 1400 according to aspects of the present disclosure. The energy management system 1400 may be located in an area whose boundaries are defined. For example, in one embodiment, the energy management system 1400 may be located in a residential community. In another embodiment, the energy management system 1400 may be located in a commercial or industrial community or in yet another embodiment, the energy management system 1400 may be located in an area where there are both residential as well as commercial or industrial buildings. The energy management system 1400 includes a plurality of energy resource systems, including EVs. The energy resource systems may be part of the residential, commercial or industrial buildings. Furthermore, the energy resource systems may be physically decoupled from the traditional power grid or, in some instances, may have a switchable connection to the power grid. In one embodiment, the energy management system 1400 is completely grid independent such that the energy resource systems need never to be connected to the power grid. In one embodiment, the energy resource systems may be connected to each other by power lines regardless of whether the energy management system 1400 is connected to the grid or grid independent.

In one embodiment, each of the energy resource system may include a renewable energy resource to generate electric power and a power converter to convert the electric power from one form to another form. The power converter may convert the electric power from Alternating Current (“AC”) to Direct Current (“DC”) or vice versa. In another embodiment, the energy resource system 1400 may include a centralized large renewable energy resource with an energy storage device 1450 such as one or more batteries or Ultracapacitors. Moreover, the renewable energy resource may include a solar power module, a wind turbine, geothermal energy resources, an EV, or a fuel cell. The energy resource system also includes energy storage to store the power generated by the renewable energy resource. Furthermore, the plurality of energy resource systems may also include water heaters for heating water when the renewable energy resource produces excess energy and converting the stored heat energy of the water back into electric power when renewable energy resource produces less energy. In one embodiment, the water heater may be a dual-fuel water heater that operates on two different sources of energy including, for example, electricity and natural gas.

A local controller is provided in the energy resource system to control the operation of the power converter. Further, a networking module is provided in the energy resource system to facilitate connection with a cloud controller. The cloud controller is communicatively coupled to the energy resource system and is configured to establish a secure connection with the local controller. In one embodiment, a secure connection is established after verification of a unique identifier of the local controller or the energy resource system. The unique identifier verification may be performed by the cloud controller in order to verify that a genuine energy resource system is communicating with it and the energy resource system is running trusted software, and/or is working on the behalf of a trusted user. The cloud controller may verify the unique identifiers (e.g., a bar code, a RFID tag, etc.) by various techniques such as utilizing password or a thumb print, a retina scan, or another form of bio-based authentication. Further, the cloud controller maintains a database for securely storing information representing energy exchanged between the plurality of energy resource systems in the form of a virtual renewable energy currency. Thus, the virtual renewable energy currency balance of a unique identifier may indicate how much energy has been received or transferred by the respective energy resource system. In one embodiment, the virtual renewable energy currency is referred to as BTU coins. In general, the virtual renewable energy currency provides an indication of amount of renewable energy that has been generated and utilized by the respective energy resource system. If an energy resource system has a balance of BTU coins for example, then it may indicate that the energy resource system has generated more renewable energy compared to the energy that it has consumed and the excess renewable energy has been transferred to another energy resource system. The owner of the energy resource system can then use those BTU coins at a later stage to receive or be granted access to renewable energy from other renewable energy resource systems either within the same community or from a remote community. For example, if the owner of the energy resource system is traveling to a remote location and needs additional renewable energy (e.g., to charge an EV), then the owner can apply their virtual renewable energy currency balance towards a renewable energy purchase transaction at an energy resource system located in the remote community. In one embodiment, the transaction details are transmitted to the cloud controller which updates the database associated with the energy resource system owner's account including, for example, their virtual renewable energy currency balance.

In one embodiment, the cloud controller utilizes a block chain technology to securely store information relating to energy exchanged between the plurality of energy resource systems. The energy exchange transactions are time stamped and are linked to each other. Once a transaction is recorded it cannot be altered retroactively.

In one embodiment, the energy exchange between two energy resource systems may be facilitated by the cloud controller which sends communications to the respective two local controllers based on the energy exchange requirements of the two energy resource systems. For example, assume that one energy resource system has a plurality of loads and at a certain time the power requirement of those plurality of loads is 2 kW. Further, assume the renewable energy resource associated with that energy resource system cannot generate enough energy to meet the power requirement of the plurality of loads. In such case, the energy resource system may then initiate a request to receive additional energy from another energy resource system which may be facilitated by the cloud controller. In another embodiment, a portable energy storage device, such as an EV may be utilized to transfer energy from one energy resource system to another. For example, an electric vehicle owner may charge their vehicle batteries while connected to one energy resource system and then may transfer the energy in the vehicle batteries into the battery of another energy resource system within the same energy management system or within a separate energy management system. As discussed earlier, in one embodiment, the energy resource system may be a centralized large energy resource with batteries. In one embodiment, a special-purpose battery vehicle having large arrays of rechargeable batteries or other energy storage devices may be utilized to move large quantities of renewable energy from one energy resource system to another or between one energy management system and another. The battery vehicle may include a HEV or an EV or a drone. The battery vehicles could be human controlled or autonomous. The autonomous vehicles could be programmed to operate in the evening to avoid quality of life disruption or to operate when demand is lower. In such case, the battery vehicles could be programmed via Global Positioning Satellite (“GPS”) systems to locate and dock with one or more charging stations associated with the large renewable energy resource associated with the energy management systems. In one embodiment, the energy management systems may be configured to send notification to one or more battery vehicles or a battery vehicle fleet, through the cloud service for example, alerting the battery vehicle fleet that the particular energy management system has excess stored energy it is willing to transfer. In one embodiment, the owners of the energy resource systems may be credited with an equal or pro-rata share of virtual renewable energy currency credits based on the amount of energy transferred to the battery vehicle(s).

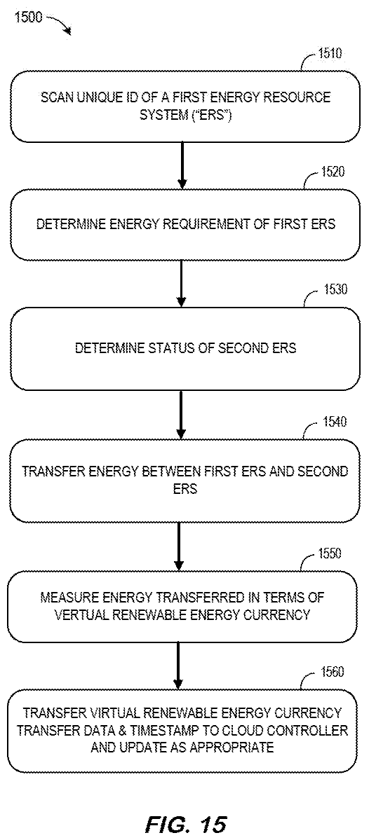

FIG. 15 shows a method 1500 of energy exchange between two energy resource system according to aspects of the present disclosure. At 1510, a unique identifier of a first energy resource system is read and its energy requirement is determined at 1520. In one embodiment, the energy requirement may be positive or negative. A positive energy requirement indicates an excess of energy at the energy resource system whereas a negative energy requirement indicates a lack of energy or requirement of more energy at the place where the energy resource system is located. At 1530, a unique identifier and status of the second energy resource system is determined. Once the unique identifiers are verified with the cloud controller and if the energy requirement at the second energy resource system is found to be sufficient to match the energy requirements of the first energy resource system, energy is transferred between the two energy resource systems at 1540. The energy transfer may be facilitated by the power converter and the local controller after the local controller receives a signal from the cloud controller. For example, in one embodiment, the voltage of the power converters of the sending energy resource system and the receiving energy resource system may be adjusted in order for transferring energy/power therebetween. The energy exchange between the two energy resource systems is measured at 1550 and transferred to the cloud controller at 1560 in terms of virtual renewable energy currency. At 1560, the record of the first and the second energy resource systems may also be updated by the cloud controller to keep the respective accounts up to date. In one embodiment, the local controller may itself track and control energy usage of the energy resource system as well as energy transfer of the energy resource system.

In one embodiment, the energy transfer between the plurality of energy resource systems is based on demand curves and energy consumption limits of the energy resource systems. In yet another embodiment, the energy transfer may be based on the time of the day or other conditions prevalent at the time of transaction. In one embodiment, the various seasons as well as geographic location at the community where the plurality of energy resource systems are located are also the factors which are taken into consideration with respect to the energy transfer mechanism. In one embodiment, an energy management mechanism may utilize machine learning techniques or other algorithms that uses various factors to facilitate energy transfer between a plurality of energy resource systems. For example, the energy transfer mechanism may utilize power generation forecasting or load forecasting algorithms based on which the energy transfer between two energy resource systems could be planned.

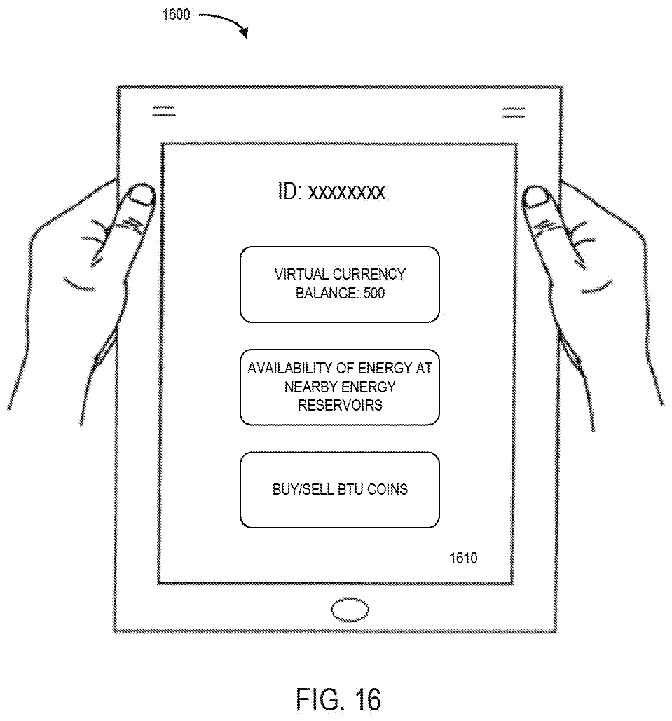

In one embodiment, the energy exchange transaction from the energy resource system to the battery vehicle may be facilitated by a handheld device which is configured to read the identification tags of the local controller. The identification tags may include, for example, radio frequency identification (RFID) tags. FIG. 16 shows one such handheld device 1600 with a display 1610. The handheld device 1600 may be a mobile phone or any other personal electronic device with an energy management application installed therein. The handheld device 1600 may exchange information with the cloud controller to facilitate the energy exchange transaction between the energy resource system and the battery vehicle or the between the two energy resource systems. The handheld device 1600 may also be connected with the local controller by other means such as by Bluetooth syncing. The handheld device 1600 may provide other information such as virtual currency balance, and availability or requirement of energy at nearby energy resource systems. Further, the handheld device 1600 may provide an option to buy or sell the virtual currency. In one embodiment, the virtual currency may be used to receive energy or may be donated to a charity outside of the area where the energy management system is located.

In yet another embodiment, the community where the energy management system is located may partner with EV companies for energy transfer transactions. For example, during the night time, when the energy requirement at the energy management system is low due to reduced loads, all the excess energy in a community may be transmitted to the EV batteries by providing a plurality of EV charging plug and play interfaces. The energy transfer from the energy management system to the EV batteries may be facilitated by a signal from the cloud controller to the local controller. Once the local controller receives the energy transfer signal then the local controller can control the power converter such that the power converter supplies higher current to charge the EV batteries.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

1. A system to facilitate energy transactions associated with a microgrid, comprising:
an energy reservoir controller associated with an energy reservoir adapted to store electrical energy for the microgrid, including:
a communication port to receive indications of digital currency tokens from at least one token creation platform via a communication network; and
an energy reservoir controller computer processor, coupled to the communication port, adapted to:
receive the indications of digital currency tokens from the token creation platform,
place at least some of the digital currency tokens into an available energy container based on an amount of energy stored in the energy reservoir,
receive, from a consumer within the microgrid, a transaction request for energy,
responsive to the transaction request, arrange for an amount of energy to be transferred from the energy reservoir to the consumer,
based on the amount of energy transferred to the consumer, automatically move a number of digital currency tokens from the available energy container into a used energy container, and
record information about the transaction request via a secure, distributed transaction ledger.

2. The system of claim 1, further comprising:
the energy reservoir, wherein the energy reservoir is a battery adapted to store electricity for the microgrid supporting between approximately three consumers to approximately several hundred consumers.

3. The system of claim 2, wherein the battery is adapted to store electricity generated by a local renewable energy source coupled to the microgrid.

4. The system of claim 3, wherein the local renewable energy source comprises at least one of: (i) solar panels, (ii) wind turbines, and (iii) a hydroelectric energy source.

5. The system of claim 1, wherein the energy reservoir controller computer processor is further adapted to:
access the token creation platform to verify data associated with the transaction request.

6. The system of claim 1, wherein the energy reservoir controller computer process is further adapted to:
prior to placing digital currency tokens into the available energy container, place digital currency tokens received from the token creation platform into a reserve container, and
based on an amount of energy stored in the energy reservoir, move at least some of the digital currency tokens from the reserve container into the available energy container.

7. The system of claim 1, wherein the microgrid is associated with a plurality of consumers, and a separate used energy container is maintained for each consumer

8. The system of claim 1, wherein the energy reservoir controller computer processor is further adapted to:
arrange to receive payment from each consumer based on the number of digital currency tokens in the associated used energy container.

9. The system of claim 1, wherein the energy reservoir controller is associated with a plurality of energy reservoirs forming a mega-reservoir.

10. The system of claim 1, wherein the microgrid energy reservoir controller is coupled to a larger energy grid, and the number digital currency tokens in the available energy container is further based on an amount of energy available from the larger energy grid.

11. The system of claim 1, wherein the indications of digital currency tokens received from the token creation platform are associated with a decentralized cryptocurrency.

12. The system of claim 1, wherein the secure, distributed transaction ledger comprises blockchain technology.

13. A computer-implemented method to facilitate energy transactions associated with a microgrid, comprising:
receiving, at a battery controller computer processor, indications of digital currency tokens from a remote token creation platform via a communication network;
placing, by the battery controller computer processor, at least some of the digital currency tokens into a reserve container;
based on an amount of electrical energy stored in a battery associated with the microgrid, moving at least some of the digital currency tokens from the reserve container into an available energy container;
receiving, from a consumer within the microgrid, a transaction request for electrical energy;
responsive to the transaction request, arranging for an amount of electrical energy to be transferred from the battery to the consumer;
based on the amount of electrical energy transferred to the consumer, automatically moving a number of digital currency tokens from the available energy container into a used energy container associated with the consumer; and
recording information about the transaction request via a secure, distributed transaction ledger.

14. The method of claim 13, wherein the battery is adapted to store electricity generated by a local renewable energy source comprising at least one of: (i) solar panels, (ii) wind turbines, and (iii) a hydroelectric energy source.

15. The method of claim 13, further comprising:
accessing the remote token creation platform to verify data associated with the transaction request.

16. The method of claim 13, further comprising:
arranging to receive payment from the consumer based on the number of digital currency tokens in the associated used energy container.

17. The method of claim 13, wherein the secure, distributed transaction ledger comprises blockchain technology.

18. A non-transitory, computer-readable medium storing program code, the program code executable by a computer processor of a battery controller to cause the battery controller to perform a method to facilitate energy transactions associated with a microgrid, comprising:
receiving indications of digital currency tokens from a remote token creation platform via a communication network;
based on an amount of energy stored in a battery associated with the microgrid, placing at least some of the digital currency tokens into an available energy container;
receiving, from a consumer within the microgrid, a transaction request for energy;
responsive to the transaction request, arranging for an amount of energy to be transferred from the battery to the consumer;
based on the amount of energy transferred to the consumer, automatically moving a number of digital currency tokens from the available energy container into a used energy container associated with the consumer; and
recording information about the transaction request via a secure, distributed transaction ledger.

19. The medium of claim 18, wherein the method performed by the battery controller further comprises:
accessing the remote token creation platform to verify data associated with the transaction request.

20. The medium of claim 18, wherein the method performed by the battery controller further comprises:
arranging to receive payment from the consumer based on the number of digital currency tokens in the associated used energy container.

21. The method of claim 18, wherein the secure, distributed transaction ledger comprises blockchain technology.
